(19) United States
(12) Patent Application Publication
(10) Pub. No.: US 2015/0000639 A1
(43) Pub. Date: Jan. 1, 2015

(54) MULTIPLE-LAYER FUEL LINE

(71) Applicant: Frankische Industrial pipes GmbH & Co. KG, Konigsberg (DE)

(72) Inventor: Manfred Krauss, Konigsberg (DE)

(73) Assignee: FRANKISCHE INDUSTRIAL PIPES GMBH & CO. KG, Konigsberg (DE)

(21) Appl. No.: 14/368,000

(22) PCT Filed: Jul. 2, 2012
(86) PCT No.: PCT/EP2012/062814

§ 371 Date: Jun. 23, 2014

(30) Foreign Application Priority Data
Dec. 22, 2011 (DE) 10 2011 089 616.3

(51) Int. Cl. F16L 9/133; F02M 37/00

(52) U.S. Cl. CPC F16L 9/133; F02M 37/0017
USPC 123/468; 138/140

(57) ABSTRACT

The invention relates to a multiple-layer fuel line, comprising an inner layer which comes into contact with the fuel and an other layer which forms the outer surface of the fuel line and is formed from a polyamide. According to the invention, the inner layer comprises polyethylene.

The invention relates to a multiple-layer fuel line comprising an inner layer which comes into contact with the fuel and an outer layer which forms the outer surface of the fuel line.

A fuel line in this context is understood to mean not only fuel lines carrying liquid fuels, but also lines that carry gas containing gaseous fuel. The fuel lines may be pressurized lines or non-pressurized lines.

As materials for the production of the outer layer, polyamides have the advantage that they provide great resistance to temperature and compressive stress. Therefore, polyamides are chiefly used today to produce fuel lines arranged inside or even outside the tank. For example, a prior-art multiple-layer fuel line comprises an inner layer made of a polyamide, an outer layer made of a polyamide, and a barrier layer arranged between these two layers that is made of an ethylene-vinyl alcohol copolymer (EVOH) which counteracts the outward diffusion of hydrocarbons from the fuel into the environment.

However, polyamides also have the disadvantage that they contain oligomers which, upon contact with the fuel, may be leached out, in particular when in contact with alcohol-containing fuel, and can clog the fuel supply system of the motor or of attached components.

The object of the invention is therefore to improve a multiple-layer fuel line of the aforementioned kind in such a way that the leaching of oligomers by the fuel conveyed therein is at least reduced, if not completely prevented.

This object is achieved according to the invention by a multiple-layer fuel line of the aforementioned type, wherein the inner layer comprises polyethylene. For the person skilled in the art, the use of polyethylene for producing fuel lines is far-fetched, per se, because its melting point, at about 120° C., is very low, in particular when compared with the melting point of PA6, at about 220° C., and that of other polyamides. In addition, the mechanical stability of polyethylene leaves something to be desired. To summarize briefly: with respect to the use for producing fuel lines, polyethylene has neither the required temperature resistance nor the required compression resistance. Surprisingly, however, it has turned out that, on the whole, the required temperature and compression resistance can nevertheless be achieved if polyethylene is used solely as a barrier layer against the leaching of oligomers, but the outer layer is still made of a polyamide.

It has also surprisingly been shown that in areas that are not subjected to such high temperatures, the outer layer may comprise polypropylene instead of polyamide, preferably being made of polypropylene or of a polypropylene-containing compound or alloy or of a polypropylene copolymer. The polypropylene-containing compound or alloy may additionally contain polyethylene or polyamide. In addition, the polypropylene copolymer may be a copolymer comprising polyethylene or/and polyamide. Finally, the polypropylene may be a modified polypropylene, for example a flame-retardant or/and thermo-stabilized or/and impact-resistant modified polypropylene.

The polyethylene used may be, for example, high-density polyethylene (HDPE) or/and cross-linked polyethylene or/and polyethylene of raised temperature resistance (PERT according to DIN 16833/34). Indeed, with the latter, PERT, the temperature problems discussed above are not as great as with HDPE and cross-linked polyethylene. What was discussed above on the issue of compression, however, applies similarly to PERT. HDPE is particularly preferably used because, in addition to the benefits discussed above, it has the additional advantage of being available inexpensively.

Preferably, the inner layer consists entirely of polyethylene. In applications where temperature resistance is a priority requirement, however, the inner layer may be made of a compound comprising polyethylene and polyamide or of an alloy comprising polyethylene and polyamide or of a polyethylene/polyamide copolymer. The proportion of polyamide in this connection can be determined as a compromise between the requirement for temperature resistance and the requirement for the absence of oligomers. In this context, it should be noted that the proportion of oligomers in the polyamide may be reduced by washing with alcohol.

By selecting the layer thickness of the inner layer in relation to the total thickness of the wall of the fuel line, the desired properties may be adjusted at will. The thinner the inner layer, i.e., the thicker consequently the polyamide layer, the better the temperature and compression resistance of the fuel line. In contrast, however, the thicker the inner layer, i.e., the thinner consequently the polyamide layer, the more economically the fuel line can be produced. To achieve the desired barrier effect against the leaching of oligomers, however, the polyethylene layer should have a minimum layer thickness of no less than 0.1 mm.

To be able to reduce, if not even completely prevent, electrostatic charges which may arise from the flow of fuel through the fuel line, it is further proposed that the inner layer coming into contact with the fuel be in the form of a conductive layer. This can be accomplished, for example, by adding carbon black or carbon nanotubes to the material out of which the inner layer is made, wherein the proportion based on the total amount is between about 10% and about 20% of carbon black, while the proportion of carbon nanotubes preferably is less than 6%.

The polyamide selected may be any suitable polyamide according to the specific requirements of each particular application, for example, PA6, PA66, PA666, PA1010, PA610, PA612, PA11, PAl2, or PPA. Thus, the outer layer of a fuel line designed to be arranged inside a fuel tank may be made of PA6, while the outer layer of a fuel line designed to be arranged outside a fuel tank may be made of PA610 or PA612.

With a fuel line intended to be arranged outside a fuel tank, an intermediate layer may additionally be provided between the inner layer and the outer layer, preferably a barrier layer which counteracts the outward diffusion of hydrocarbons. In this way, unwanted emissions can be reliably prevented. Such intermediate layers can be omitted when using diesel as fuel, because diesel has a significantly lower tendency to diffuse outward than other fuels. The intermediate layer can be made, for example, of ethylene-vinyl alcohol copolymer (EVOH), polyvinylidene fluoride (PVDF), polyoxymethylene (POM) or ethylene tetrafluoroethylene (ETFE). Preferably, however, EVOH is used, because on the one hand it is available inexpensively and on the other hand it meets the requirements of a hydrocarbon barrier material.

To be able to reliably ensure good cohesion of the individual layers, a development of the invention may provide for an adhesion promoter layer to be provided between the inner layer and its adjacent layer, namely the outer layer or the intermediate layer, or/and may provide for an adhesion promoter layer to be provided between the outer layer and the intermediate layer. The material of the adhesion promoter layer may be based on polyethylene or/and polypropylene or/and polyamide to achieve the best possible structural compatibility of the mutually adjacent layers at a molecular level. In addition, a polyamide-based adhesion promoter layer, for example PA6, has the additional advantage that the adhesion promoter layer can increase the stiffness or/and resistance to compression of the fuel line.

Alternatively, the fuel line according to the invention may be made of a smooth tube or a corrugated tube.

### EXAMPLES

### Example 1

A smooth tube having an outside diameter of 8 mm and a wall thickness of 1 mm comprises four layers. The outer layer is made of PA612 and has a layer thickness of 0.45 mm±0.05 mm. The inner layer is made of HDPE and has a layer thickness of 0.35 mm±0.05 mm. A hydrocarbon barrier layer made of an

EVOH having a layer thickness of 0.10 mm±0.03 mm is provided between these two layers. A polyethylene-based adhesion promoter layer having a layer thickness of 0.10 mm±0.03 mm is provided between the EVOH layer and the inner layer made of HDPE.

This tube is suitable for use outside the tank. The great layer thickness of the PA612 gives this tube good resistance to compression.

### Example 2

A smooth tube having an outside diameter of 8 mm and a wall thickness of 1 mm comprises five layers. The outer layer is made of PA612 and has a layer thickness of 0.30 mm±0.05 mm. The inner layer is made of HDPE and has a layer thickness of 0.35 mm±0.05 mm. A hydrocarbon barrier layer made of an EVOH having a layer thickness of 0.15 mm±0.03 mm is provided between these two layers. Both between the EVOH layer and the inner layer made of HDPE, and between the EVOH layer and the outer layer made of PA612 an additional polyethylene-based adhesion promoter layer is provided having a layer thickness of 0.10 mm±0.03 mm.

This tube is suitable for use outside the tank, as well. The smaller layer thickness of the PA612 causes this tube to have correspondingly lower compression resistance than the tube of Example 1.

### Example 3

A smooth tube having an outside diameter of 8 mm and a wall thickness of 1 mm comprises five layers. The outer layer is made of PP and has a layer thickness of 0.30 mm±0.05 mm. The inner layer is made of HDPE and has a layer thickness of 0.35 mm±0.05 mm. A hydrocarbon barrier layer is provided between these two layers that is made of an EVOH having a layer thickness of 0.15 mm±0.03 mm. A polyimide-based adhesion promoter layer having a layer thickness of 0.10 mm±0.03 mm is provided both between the EVOH layer and the inner layer made of HDPE as well as between the EVOH layer and the outer layer made of PP.

This tube is suitable for use outside the tank, as well. The smaller layer thickness of the outer layer and the use of PP as the material for the outer layer causes this tube to have correspondingly lower compression resistance than the tubes according to Examples 1 and 2. Owing to the proportion of PP, however, it is more cost effective to produce than the tubes according to Examples 1 and 2.

### Example 4

A smooth tube having an outside diameter of 8 mm and a wall thickness of 1 mm comprises three layers. The outer layer is made of PA612 and has a layer thickness of 0.40 mm±0.05 mm. The inner layer is made of HDPE and has a layer thickness of 0.50 mm±0.03 mm. And provided between these two layers is a polyethylene-based adhesion promoter layer having a layer thickness of 0.10 mm±0.03 mm.

Due to the absence of a hydrocarbon barrier layer, this tube is intended for use inside the tank. The great thickness of the HDPE layer causes this tube to have low resistance to compression.

### Example 5

A smooth tube having an outside diameter of 8 mm and a wall thickness of 1 mm comprises three layers. The outer layer is made of PP and has a layer thickness of 0.40 mm±0.05 mm. The inner layer is made of HDPE and has a layer thickness of 0.50 mm±0.03 mm. And provided between these two layers is a polyamide-based adhesion promoter layer having a layer thickness of 0.10 mm±0.03 mm.

Due to the absence of the hydrocarbon barrier layer, this tube is intended for use inside the tank. The great layer thickness of the HDPE causes this tube to have low resistance to compression. Owing to the proportion of PP, however, it is more cost effective to produce than the tube according to Example 4.

All of the examples have in common that they have an outer diameter of 8 mm and a wall thickness of 1 mm, and in addition have a tensile stress at yield in the direction of extrusion of at least 20 MPa, a tensile strain at break of at least 250% and an equivalent stress of at least 15 MPa.

1. A multiple-layer fuel line comprising:
an inner layer which comes into contact with the fuel, the inner layer comprising polyethylene, and
an outer layer which forms the outer surface of the fuel line, the outer layer comprising polyamide or/and polypropylene.

2. The fuel line according to claim 1, wherein that the outer layer is made of polyamide.

3. The fuel line according to claim 1, wherein the outer layer is made of polypropylene or of a polypropylene-containing compound or alloy or of a polypropylene copolymer.

4. The fuel line according to claim 1, wherein the inner layer is made of a compound containing polyethylene and polyamide or of an alloy containing polyethylene or polyamide, or of a polyethylene/polyamide copolymer.

5. The fuel line according to claim 1, wherein the polyethylene is high density polyethylene (HDPE) or/and cross-linked polyethylene or/and polyethylene of raised temperature resistance (PE-RT).

6. The fuel line according to claim 1, wherein the inner layer has a layer thickness of not less than 0.10 mm.

7. The fuel line according to claim 1, wherein the inner layer coming into contact with the fuel is in the form of a conductive layer.

8. The fuel line according to claim 1, wherein the polyamide is selected from the group comprising PA6, PA66, PA666, PA1010, PA610, PA612, PA11, PA12 and PPA.

9. The fuel line according to claim 1, wherein the outer layer of a fuel line adapted to be arranged inside a fuel tank is made of PA6.

10. The fuel line according to claim 1, wherein the outer layer of a fuel line adapted intended to be arranged outside a fuel tank is made of PA610 or PA612.

11. The fuel line according to claim 1, wherein, for a fuel line adapted to be arranged outside a fuel tank, an intermediate layer is provided between the inner layer and the outer layer, the intermediate layer being a barrier layer that counteracts the outward diffusion of hydrocarbons.

12. The fuel line according to claim 11, wherein the intermediate layer is made of a material selected from the group comprising ethylene vinyl alcohol copolymer (EVOH), polyvinylidene fluoride (PVDF), polyoxymethylene (POM) and ethylene tetrafluoroethylene (ETFE).

13. The fuel line according to claim 1, wherein an adhesion promoter layer is provided between the inner layer and its adjacent layer.

14. The fuel line according to claim 1, wherein an adhesion promoter layer is provided between the outer layer and the intermediate layer.

15. The fuel line according to claim 11, wherein the material of the adhesion promoter layer is produced based on polyethylene or/and polypropylene or/and polyamide.

16. The fuel according to claim 14, wherein the material of the adhesion promoter layer is produced based on polyethylene or/and polypropylene or/and polyamide.
